(19) United States
(12) Patent Application Publication
(10) Pub. No.: US 2005/0170277 A1
(43) Pub. Date: Aug. 4, 2005

(54) Fluorinated photoresists prepared, deposited, developed and removed in carbon dioxide

(76) Inventors: Luke Zannoni, Chapel Hill, NC (US); Joseph DeSimone, Chapel Hill, NC (US); Evan Hicks, Durham, NC (US); Colin Wood, Carrboro, NC (US)

Correspondence Address: MYERS BIGEL SIBLEY & SAJOVEC, PO BOX 37428, RALEIGH, NC, 27627, US

(21) Appl. No.: 10/968,390

(22) Filed: Oct. 19, 2004

Related U.S. Application Data
(60) Provisional application No. 60/512,685, filed on Oct. 20, 2003.
(60) Provisional application No. 60/513,049, filed on Oct. 21, 2003.

(51) Int. Cl. G03C 1/76

(52) U.S. Cl. 430/270.1

(57) ABSTRACT

The present invention provides a compound that is a terpolymer of: (a) at least one ethylenically unsaturated linear or branched compound that has at least one fluorine atom covalently coupled thereto; (b) at least one ethylenically unsaturated precursor of a cyclic or polycyclic compound that has at least one fluorine atom covalently coupled thereto forming a cyclic or polycyclic decrystallizing monomer in said terpolymer; and (c) at least one ethylenically unsaturated functional compound which as a monomer in said terpolymer changes solubility upon exposure to an acid or base. Methods of making and using such compounds in photolithography are also described

### RELATED APPLICATIONS

This application claims the benefit of U.S. Provisional Patent Application Ser. No. 60/512,685, filed Oct. 20, 2003, and of U.S. Provisional Patent Application Ser. No. 60/513,049, filed Oct. 21, 2003, the disclosures of both of which are incorporated by reference herein in their entirety.

### FIELD OF THE INVENTION

The present invention concerns photoresist compositions useful for, among other things, 157 nm and 193 nm photolithography and imageable low k dielectrics.

### BACKGROUND OF THE INVENTION

Teflon® AF is an amorphous copolymer of tetrafluoroethylene (TFE) and 2,2-bis(trifluoro-methyl)-4,5-difluoro-1,3-dioxole (PDD) (Scheme 1). It combines the properties of amorphous plastics like good optical transparency and solubility in organic solvents with those of perfluorinated polymers like high thermal stability, excellent chemical stability and a low surface energy. Moreover Teflon® AF has some unique properties: it has the lowest dielectric constant (1.90 for Teflon® AF 2400) and the lowest refractive index (1.29 for Teflon® AF 2400) known for a solid organic polymer (Resnick, P. R.; Buck, W. H. In Modern Fluoropolymers; Scheirs, J., Ed.; John Wiley & Sons: Chichester, 1997, p. 397). The low refractive index and exceptional optical clarity from ultraviolet into infrared wavelengths makes it well-suited for use as an optical material. The synthesis of TFE and PDD in supercritical carbon dioxide has previously been demonstrated (Scheme 1)(Michel, U.; Resnick, P.; Kipp, B.; Desimone, J. M. Macromolecules 2003, 36, 7107-7113). Copolymers of TFE and PDD were prepared with glass transition temperatures ranging from 67° C. to 334° C. by varying the amount of PDD present in the chain. 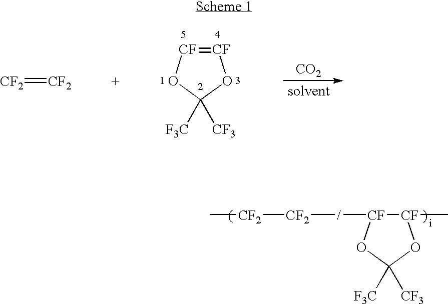
A major challenge in the development of 157 nm and 193 nm photolithography is that resists must transmit at least 40% of the incident level to the bottom of the resist layer to avoid photoresist line profiles after development (French, R. H.; Wheland, R. C.; Weiming, Q.; Lemon, M. F.; Zhang, E.; Gordon, J.; Petrov, V. A.; Cherstkov, V. F.; Delaygina, N. I. J. Fluorine Chem., 2003, 122, 63-80). Teflon® AF was one of the first materials to exhibit the required transparencies at these low wavelengths. However, the copolymer lacks the chemical functionality required of a photoresist to exhibit a solubility contrast after exposure. See, e.g., U.S. Pat. No. 6,593,058 to Feiring and Feldman; PCT Application No. WO 00/67072 to Feiring and Feldman; EPO Application No. 1246013.

### SUMMARY OF THE INVENTION

A first aspect of the present invention is a compound that is a terpolymer of: (a) at least one ethylenically unsaturated linear or branched compound that has at least one fluorine atom covalently coupled thereto; (b) at least one ethylenically unsaturated precursor of a cyclic or polycyclic compound that has at least one fluorine atom covalently coupled thereto forming a cyclic or polycyclic decrystallizing monomer in said terpolymer; and (c) at least one ethylenically unsaturated functional compound which as a monomer in said terpolymer changes solubility upon exposure to an acid or base.

A second aspect of the present invention is a photoresist comprising a terpolymer as described above and at least one photoactive component. The photoresist may optionally contain a dissolution inhibitor, along with any of a variety of other ingredients.

A third aspect of the present invention process for preparing a photoresist image on a substrate, comprising: (a) applying a photoresist composition on a substrate, wherein said photoresist composition comprises (i) a terpolymer as described above, (ii) a photoactive component, and (iii) a solvent (preferably a carbon dioxide solvent); (b) drying the photoresist composition to substantially remove the solvent and thereby form a photoresist layer on the substrate; (c) imagewise exposing the photoresist layer to form imaged and non-imaged areas; and (d) developing the exposed photoresist layer having imaged and non-imaged areas to form the relief image on the substrate.

A fourth aspect of the present invention is a method of making a terpolymer as described above, comprising the steps of:
(a) providing a bipolymer of (i) at least one ethylenically unsaturated linear or branched compound that has at least one fluorine atom covalently coupled thereto and (ii) at least one ethylenically unsaturated cyclic or polycyclic compound that has at least one fluorine atom covalently coupled thereto forming a decrystallizing monomer in said terpolymer; and
(b) reacting said bipolymer with at least one ethylenically unsaturated functional compound which as a monomer in said terpolymer changes solubility upon exposure to an acid or base in a carbon dioxide solvent produce the terpolymer described above.

The foregoing and other objects and aspects of the present invention are explained in greater detail in the drawings herein and the specification set forth below.

### DETAILED DESCRIPTION OF THE PREFERRED EMBODIMENTS

“Terpolymer” as used herein refers to a copolymer obtained from copolymerization of three monomers.

“Ester vinyl ether” as used herein includes fluorovinyl ethers of the formula CF2═CFOQZ where Q is a alkylene radical, including fluorinated and perfluorinated alkylene radicals, containing 0-4 ether oxygen atoms, wherein the sum of the C and O atoms in Q is 2 to 10; and Z is a group selected from the class consisting of —COOR and —SO₂F, where R is a C1-C4 alkyl.”

“Decrystalizing monomer” as used herein refers to a monomer which incorporated into a copolymer decrystallizes the copolymer or renders the copolymer amorphous, preferably while maintaining the Tg of the copolymer above room temperature.

The disclosures of all United States patent references cited herein are to be incorporated herein in their entirety.

A. Terpolymers and Methods of Making.

Linear or branched ethylenically unsaturated compounds that can be used to carry out the present invention include, but are not limited to, tetrafluoroethylene, chlorotrifluoroethylene, trifluoroethylene, vinylidene fluoride, and vinyl fluoride.

Cyclic or polycyclic compounds that can be used as precursors for cyclic or polycyclic decrystalizing monomers to carry out the present invention include but are not limited to perfluoro-(,2-dmethyl-1,3-dioxole) (PDD) and perfluoro-(2-methylene-4-methyl-1,3-dioxolane), as well as compounds that are linear or branched in monomeric form but form cyclic compounds when integrated into the copolymer, such as the CYTOP® monomer developed by Asahi Glass Company shown below, which forms the cyclic structure in the copolymer as shown below:

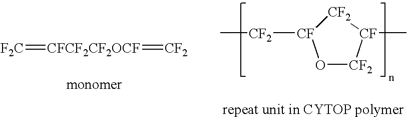

Functional compounds that can be used to carry out the present invention, are in general, compounds in which an ethylenically unsaturated group is coupled to a leaving group by an acid-cleavable linkage, such as an ester or carboxylate linkage. Such compounds include compounds of the formula R₁—COO—R₂ or R₂—COO—R₁, where R₁ is an ethylenically unsaturated group and R₂ is an aromatic or aliphatic leaving group. Preferred leaving groups are cyclic, linear or branched C1 to C8 alkyl groups which may contain 1 or 2 hetero atoms such as O S, or N. Examples of suitable functional compounds include but are not limited to:

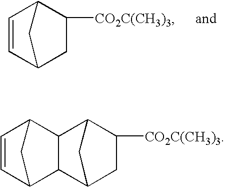

Additional examples of functional compounds that vsn be used to carry out the present invention include:

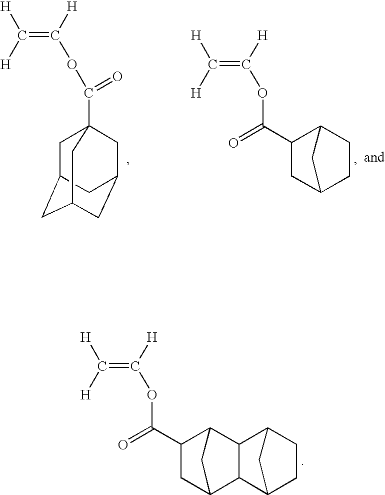

Additional examples of functional compounds that can be used to carry out the present invention include: 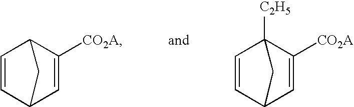
where A═H, C(CH₃)₃, or Si(CH₃)₃.

Additional examples of suitable functional compounds are:

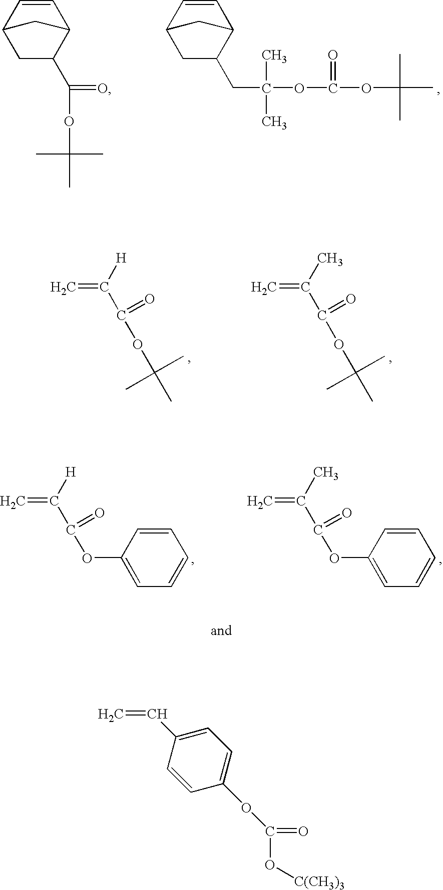

Still more examples of functional compounds that can be used in carrying out the present invention include, but are not limited to, vinyl acetate, tert-butyl acrylate, and 5-norbornene-2-carboxylic acid tert-butyl ester.

In some embodiments the at least one ethylenically unsaturated functional compound is an ester vinyl ether, and preferably a fluorinated ester vinyl ether, examples of which include but are not limited to: 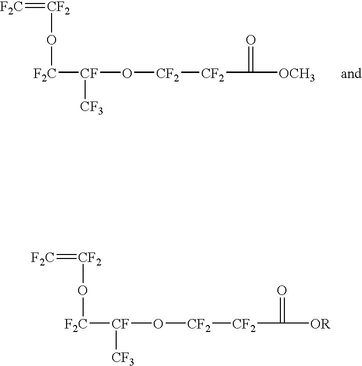
where R is a suitable aromatic or aliphatic protecting group such as loweralkyl (ethyl, t-butyl), C₆H₅, THP, or any of the protecting groups shown on the carboxylic acid groups in the compounds or monomers listed above.

Terpolymers of the present invention can be produced by polymerization in a suitable solvent, preferably a carbon dioxide solvent such as liquid or supercritical carbon dioxide, by any suitable reaction. For example, terpolymers of the present invention A may be prepared by bulk, solution, suspension or emulsion polymerization techniques known to those skilled in the art using the free radical initiators, such as azo compounds or peroxides, by other procedures known to those skilled in the art (see, e.g., U.S. Pat. No. 6,593,058 to Fiering et al.; U.S. Pat. Nos. 5,496,901 or 5,922,833 to DeSimone), or variations thereof which will be apparent to those skilled in the art based on the instant disclosure. In general, the mole percentages of each comonomers in the copolymer can range from 5 or 10 percent to 90 or 95%.

In grafting reactions of the present invention where a third monomer is placed on a preexisting “bipolymer” grafting may be carried out by any suitable technique such as with a radiation, peroxide or other radical source, such as described in U.S. Pat. No. 5,736,610.

In an an example of the invention, Ester Vinyl Ether (EVE), which contains an ester group that may be cleaved with exposure to acid, readily reacts with TFE and PDD in supercritical carbon dioxide in good yield (Scheme 2,3). The resulting terpolymers, exhibiting exceptional optical and thermal properties, serve as a basis for very low absorbing functional photoresists materials containing PDD. 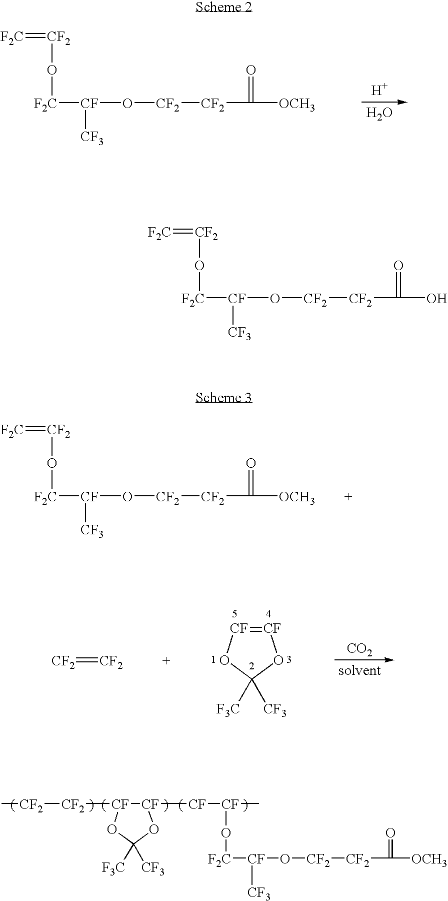
B. Photoresist Compositions.

Photoresist compositions comprise the polymers described above in combination with additional ingredients, as described further below.

Photoactive Component (PAC). The compositions of the invention contain at least one photoactive component (PAC) that usually is a compound that affords either acid or base upon exposure to actinic radiation. If an acid is produced upon exposure to actinic radiation, the PAC is termed a photoacid generator (PAG). If a base is produced upon exposure to actinic radiation, the PAC is termed a photobase generator (PBG). Suitable photoacid generators for this invention include, but are not limited to, 1) sulfonium salts, 2) iodonium salts, and 3) hydroxamic acid esters, including but not limited to those described in U.S. Pat. No. 6,593,058 to Feiring et al.

Protective Groups for Removal by PAC Catalysis. The fluorine-containing terpolymers of the resist compositions of this invention may contain one or more components having protected acid groups that can yield, by catalysis of acids or bases generated photolytically from photoactive compounds (PACs), hydrophilic acid or base groups which enable development of resist coatings. A given protected acid group is one that is normally chosen on the basis of its being acid labile, such that when photoacid is produced upon imagewise exposure, the acid will catalyze deprotection and production of hydrophilic acid groups that are necessary for development under aqueous conditions. In addition, the fluorine-containing copolymers may also contain acid functionality that is not protected.

Examples of components having protected acid groups that yield a carboxylic acid as the hydrophilic group upon exposure to photogenerated acid include, but are not limited to, A) esters capable of forming, or rearranging to, a tertiary cation, B) esters of lactone, C) acetal esters, D) beta-cyclic ketone esters, E) alpha-cyclic ether esters, and F) MEEMA (methoxy ethoxy ethyl methacrylate) and other esters which are easily hydrolyzable because of anchimeric assistance. Some specific examples in category A) are t-butyl ester, 2-methyl-2-adamantyl ester, and isobornyl ester. Some specific examples in category B) are gamma-butyrolactone-3-yl, gamma.-butyrolactone-2-yl, mavalonic lactone, 3-methyl-gamma-butyrolactone-3-yl, 3-tetrahydrofuranyl, and 3-oxocyclohexyl. Some specific examples in category C) are 2-tetrahydropyranyl, 2-tetrahydrofuranyl, and 2,3-propylenecarbonate-1-yl. Additional examples in category C) include various esters from addition of vinyl ethers, such as, for example, ethoxy ethyl vinyl ether, methoxy ethoxy ethyl vinyl ether, and acetoxy ethoxy ethyl vinyl ether.

Examples of components having protected acid groups that yield an alcohol as the hydrophilic group upon exposure to photogenerated acid or base include, but are not limited to, t-butoxycarbonyl (t-BOC), t-butyl ether, and 3-cyclohexenyl ether.

In this invention, often, but not always, the components having protected groups are repeat units having protected acid groups that have been incorporated in the base copolymer resins of the compositions (as discussed supra). Frequently the protected acid groups are present in one or more comonomer(s) that are polymerized to form a given copolymeric base resin of this invention. Alternatively, in this invention, a copolymeric base resin can be formed by copolymerization with an acid-containing comonomer and then subsequently acid functionality in the resulting acid-containing copolymer can be partially or wholly converted by appropriate means to derivatives having protected acid groups. As one specific example, a copolymer of TFE/NB/t-BA (copolymer of tetrafluoroethylene, norbornene, and t-butyl acrylate) is a copolymeric base resin within the scope of the invention having t-butyl ester groups as protected-acid groups.

Dissolution Inhibitors and Additives. Various dissolution inhibitors can be utilized in this invention. Ideally, dissolution inhibitors (DIs) for far and extreme UV resists (e.g., 193 nm resists) should be designed/chosen to satisfy multiple materials needs including dissolution inhibition, plasma etch resistance, and adhesion behavior of resist compositions comprising a given DI additive. Some dissolution inhibiting compounds also serve as plasticizers in resist compositions.

A variety of bile-salt esters (i.e., cholate esters) are particularly useful as DIs in the compositions of this invention. Bile-salt esters are known to be effective dissolution inhibitors for deep UV resists, beginning with work by Reichmanis et al. in 1983. (E. Reichmanis et al., “The Effect of Substituents on the Photosensitivity of 2-Nitrobenzyl Ester Deep UV Resists”, J. Electrochem. Soc. 1983, 130, 1433-1437.) Bile-salt esters are particularly attractive choices as DIs for several reasons, including their availability from natural sources, their possessing a high alicyclic carbon content, and particularly for their being transparent in the deep and vacuum UV region, (which essentially is also the far and extreme UV region), of the electromagnetic spectrum (e.g., typically they are highly transparent at 193 nm). Furthermore, the bile-salt esters are also attractive DI choices since they may be designed to have widely ranging hydrophobic to hydrophilic compatibilities depending upon hydroxyl substitution and functionalization.

Representative bile-acids and bile-acid derivatives that are suitable as additives and/or dissolution inhibitors for this invention include, but are not limited to, those shown in U.S. Pat. No. 6,593,058 to Feiring et al.

The invention is not limited to use of bile-acid esters and related compounds as dissolution inhibitors. Other types of dissolution inhibitors, such as various diazonaphthoquinones (DNQs) and diazocoumarins (DCs), can be utilized in this invention in some applications. Diazanaphthoquinones and diazocoumarins are generally suitable in resists compositions designed for imaging at higher wavelengths of UV light (e.g., 365 nm and perhaps at 248 nm). These dissolution inhibitors are generally not preferred in resist compositions designed for imaging with UV light at 193 nm or lower wavelengths, since these compounds absorb strongly in this region of the UV and are usually not sufficiently transparent for most applications at these low UV wavelengths.

Components for Negative-Working Photoresist Embodiment. Some embodiments of this invention are negative-working photoresists. These negative-working photoresists comprise at least one binder polymer comprised of acid-labile groups and at least one photoactive component that affords photogenerated acid. Imagewise exposure of the resist affords photogenerated acid which converts the acid-labile groups to polar functionality (e.g., conversion of ester functionality (less polar) to acid functionality (more polar)). Development is then done in an organic solvent or critical fluid (having moderate to low polarity), which results in a negative-working system in which exposed areas remain and unexposed areas are removed.

A variety of different crosslinking agents can be employed as required or optional photoactive component(s) in the negative-working compositions of this invention. (A crosslinking agent is required in embodiments that involve insolubilization in developer solution as a result of crosslinking, but is optional in preferred embodiments that involve insolubilization in developer solution as a result of polar groups being formed in exposed areas that are insoluble in organic solvents and critical fluids having moderate/low polarity). Suitable crosslinking agents include, but are not limited to, various bis-azides, such as 4,4′-diazidodiphenyl sulfide and 3,3′-diazidodiphenyl sulfone. Preferably, a negative-working resist composition containing a crosslinking agent(s) also contains suitable functionality (e.g., unsaturated C.dbd.C bonds) that can react with the reactive species (e.g., nitrenes) that are generated upon exposure to UV to produce crosslinked polymers that are not soluble, dispersed, or substantially swollen in developer solution, which consequently imparts negative-working characteristics to the composition.

Other Components. The compositions of this invention can contain optional additional components. Examples of additional components which can be added include, but are not limited to, resolution enhancers, adhesion promoters, residue reducers, coating aids, plasticizers, and Tg (glass transition temperature) modifiers.

C. Process Steps

Imagewise Exposure. The photoresist compositions of this invention are sensitive in the ultraviolet region of the electromagnetic spectrum and especially to those wavelengths ≦365 nm. Imagewise exposure of the resist compositions of this invention can be done at many different UV wavelengths including, but not limited to, 365 nm, 248 nm, 193 nm, 157 nm, and lower wavelengths. Imagewise exposure is preferably done with ultraviolet light of 248 nm, 193 nm, 157 nm, or lower wavelengths; is more preferably done with ultraviolet light of 193 nm, 157 nm, or lower wavelengths; and is still more preferably done with ultraviolet light of 157 nm or lower wavelengths. Imagewise exposure can either be done digitally with a laser or equivalent device or non-digitally with use of a photomask. Digital imaging with a laser is preferred. Suitable laser devices for digital imaging of the compositions of this invention include, but are not limited to, an argon-fluorine excimer laser with UV output at 193 nm, a krypton-fluorine excimer laser with UV output at 248 nm, and a fluorine (F2) laser with output at 157 nm. Since use of UV light of lower wavelengths for imagewise exposure corresponds to higher resolution (lower resolution limit), the use of a lower wavelength (e.g., 193 nm or 157 nm or lower) is generally preferred over use of a higher wavelength (e.g., 248 nm or higher). Specifically, imaging at 157 nm is preferred over imaging at 193 nm for this reason.

Development. The terpolymers in the resist compositions of this invention must contain sufficient functionality for development following imagewise exposure to UV light. Preferably, the functionality is acid or protected acid such that aqueous development is possible using a basic developer such as sodium hydroxide solution, potassium hydroxide solution, or ammonium hydroxide solution.

When an aqueous processable photoresist is coated or otherwise applied to a substrate and imagewise exposed to UV light, development of the photoresist composition may require that the binder material should contain sufficient acid groups (e.g., carboxylic acid groups) and/or protected acid groups that are at least partially deprotected upon exposure to render the photoresist (or other photoimageable coating composition) processable in aqueous alkaline developer. In case of a positive-working photoresist layer, the photoresist layer will be removed during development in portions which are exposed to UV radiation but will be substantially unaffected in unexposed portions during development by aqueous alkaline liquids such as wholly aqueous solutions containing 0.262 N tetramethylammonium hydroxide (with development at 25° C. usually for less than or equal to 120 seconds) or 1% sodium carbonate by weight (with development at a temperature of 30° C. usually for less than 2 or equal to 2 minutes). In case of a negative-working photoresist layer, the photoresist layer will be removed during development in portions which are unexposed to UV radiation but will be substantially unaffected in exposed portions during development using either a critical fluid or an organic solvent.

A critical fluid, as used herein, is one or more substances heated to a temperature near or above its critical temperature and compressed to a pressure near or above its critical pressure. Critical fluids in this invention are at least at a temperature that is higher than 15° C. below the critical temperature of the fluid and are at least at a pressure higher than 5 atmosphers below the critical pressure of the fluid. Carbon dioxide may be used for the critical fluid in the present invention. Various organic solvents can also be used as developer in this invention. These include, but are not limited to, halogenated solvents and non-halogenated solvents. Halogenated solvents are preferred and fluorinated solvents are more preferred.

The present invention is explained in greater detail in the following non-limiting Examples.

### EXPERIMENTAL

A. Materials and methods.

Reagents. TFE was obtained from DuPont as a 50 weight-% mixture in CO₂ and used as received. PDD (DuPont) was purified by filtration through silica gel (230-400 mesh, Sigma). EVE was obtained from DuPont and purified before use by distillation. Teflon® AF 1601 (fluorinated and unfluorinated) was obtained from DuPont. SFC purity CO₂ was obtained from Air Products. Bis(perfluoro-2-N-propoxypropionyl) peroxide was prepared in 1,1,2-trichloro-1,2,2-trifluoroethane (Freon® 113), according to known procedures (Zhao, C.; Zhou, R.; Pan, H.; Jin, X.; Qu, Y.; Wu, C.; Jiang, X. J. Org. Chem. 1980, 47, 2009-2013), and stored over dry ice. The concentration was determined by iodometry and was typically 11 weight-%.

Copolymerization of Tetrafluoroethylene, PDD and EVE in CO₂. Polymerizations were conducted in a 25 mL high-pressure reaction view cell equipped with a stirring bar, thermocouple, rupture disc and a sapphire window permitting visual observation of the reaction mixture with an endoscope. The high-pressure cell was purged with CO₂ to remove oxygen and cooled to about 5° C. with an ice-bath before EVE and PDD were charged via syringe while purging with argon. After sealing the cell the ice-bath was removed and the TFE/CO₂ mixture (50 wt.-%) was introduced with a manual pump (HIP, Model 62-6-10) under stirring. To weigh in a determined amount of TFE the pump was pressurized to 103 bar (1500 psig). The volume of the TFE/CO₂ mixture was calculated from the density at 103 bar (1500 psig). By repeated opening of the valve between the pump and the reaction view cell and repressurizing to 103 bar (1500 psig) the calculated volume was introduced. During this procedure the temperature of the autoclave stayed below 10° C. Then the reaction view cell was heated to the desired reaction temperature (typically between 15° C.-35° C.) and the initiator solution (Bis(perfluoro-2-N-propoxypropionyl) peroxide) was transferred via syringe to a small tube connected to the CO₂ line. The reaction view cell was then pressurized with additional CO₂ using an automatic syringe pump (ISCO, Model 260 D) while simultaneously introducing the initiator. After the reaction, the CO₂ was slowly released and the residual copolymer in the high-pressure cell was extracted three times to 138 bar (2000) psig with CO₂ to remove unreacted monomer and initiator residue.

Characterization. Glass transition temperatures were measured with a Seiko Instruments DSC 220 system under nitrogen. Heating rates for DSC measurements were 10 K/min. NMR spectra were measured of solutions in hexafluorobenzene (10 weight-%) at room temperature. The ¹⁹F-NMR spectra were observed on a 400 MHz spectrometer and trifluorotoluene as internal standard. The resonance of hexafluorobenzene was presaturated. A 5 mm NMR-tube with an insert filled with deuterated benzene was used as an internal lock. The parameters of the ¹⁹F-NMR nuclei were as follows: the 90° pulse was 8.40 μs, the sweep width was 200 ppm, the number of transients was 512 and the relaxation delay 10 s. IR spectra were taken of polymer films on NaCl plates (Bruker IFS 66v/S). The films were cast from solutions in Fluorinert® FC-75. Absorbance measurements were conducted by Will Conley at International SEMATECH using a VUV-VASE. Films for absorbance were cast from solutions in Fluorinert® FC-40 onto two inch wafers.

B. Results and Discussion

Influence of Reaction Conditions on Polymer Properties. Copolymers of TFE, PDD and EVE were synthesized in CO₂ and characterized using NMR spectroscopy, IR spectroscopy, differential scanning calorimetry (DSC) and VUV-VASE (Table 1). The resulting glassy, brittle materials exhibited solubilites similar to Teflon® AF in hexafulorobenzene, Fluorinert® FC-75 and Fluorinert® FC-40. Free standing films of the materials were cast from 5 wt % solutions of FC-75 and FC-40.

TABLE 1

| | | EVE/PDD/ | | | | | EVE/PDD/ | | |
|---|---|---|---|---|---|---|---|---|---|
| | | TFE | | | | Rxn. | TFE | | |
| | | Charged | Initiator | Pressure | c^{a} | Time | Comp. | Yield | T_{g}^{b} |
| No. | (° C.) | (mol- %) | (mol- %) | (psi) | (%) | (hr) | (mol- %) | (%) | (° C.) |
| 1 | 15 | 7/73/20 | 1 | 3500 | 22 | 4 | — | 56 | 160 |
| 2 | 35 | 25/55/20 | 0.2 | 3500 | 19 | 4 | 18/54/28 | 30 | 109 |
| 3 | 15 | 25/55/20 | 0.2 | 3500 | 21 | 0.5 | — | 5 | — |
| 4 | 15 | 25/55/20 | 1 | 1500 | 18 | 4 | — | 16 | — |
| 5 | 5 | 7/73/20 | 1 | 3500 | 19 | 0.5 | — | 42 | 143 |
| 6 | 5 | 10/71/19 | 0.2 | 1500 | 19 | 4 | 7/61/32 | 38 | 133 |
| 7 | 5 | 26/54/20 | 1 | 1500 | 20 | 0.5 | — | 19 | — |
| 8 | 15 | 8/72/20 | 0.2 | 1500 | 17 | 0.5 | — | 28 | — |
| 9 | 35 | 18/63/19 | 0.2 | 3500 | 20 | 20 | 12/59/29 | 30 | — |

^{a}concentration of monomers (w/v)
^{b}determined during second heating: 25-400° C., first heating: 25-300° C., heating rate: 10° C./min

Polymerization yields ranged between 5% and 56% depending on the reaction conditions. A series of eight experiments were conducted using a Plackett-Burman statistical model to observe the effects of monomer feed ratios, initiator concentration, temperature, pressure and reaction time. As expected, yields increased with lower percent EVE in feed, higher temperature, higher initiator concentration, higher pressure and longer reaction time.

¹⁹F-NMR spectroscopy was used to provide quantitative information about the compositions of the terpolymers. The percentage of EVE incorporated into the polymer chain as determined by NMR spectra integration increased with increasing amounts of EVE in the monomer feed. NMR peaks were assigned based on analysis of the EVE monomer and previous work by DeSimone and colleagues.

IR spectra confirmed the incorporation of EVE in the polymer chain with the appearance of a carbonyl stretch at 1800 cm⁻¹ that is not present in the spectra for copolymers of TFE and PDD. Comparison of the IR spectra for terpolymers with varying degrees of EVE incorporation shows an increase in intensity of the carbonyl peak relative to other peaks as EVE is introduced

TABLE 2

| | EVE | | | |
|---|---|---|---|---|
| No. | (mol- %) | L1 | L2 | L2/L1 |
| 5 | — | 48.7 | 73.0 | 1.50 |
| 6 | 7 | 42.3 | 71.7 | 1.70 |
| 9 | 12 | 43.7 | 82.0 | 1.87 |
| 2 | 18 | 42.2 | 82.3 | 1.95 |

Glass transition temperatures, as observed by DSC, decrease with increasing EVE content. This is as expected as the TFE content is held roughly constant and the more freely rotating EVE monomer replaces the presence of PDD. However, even at 18 mol % EVE incorporation, the glass transition temperature of the resulting material is 109° C. This suggests that the thermal properties of a PDD/TFE-based terpolymer should be suitable for photolithographic applications.

Absorbance at 157.6 nm, as measured by VUV-VASE, initially decreased compared to that of Teflon® AF the incorporation of 7 mol % EVE and then increased as additional EVE was incorporated into the polymer chain (Table 3). The increased absorbance can be explained by the increasing presence of the carbonyl group associated with EVE. Also, as TFE is held roughly constant, increasing amounts of EVE in the chain replace the very low absorbing PDD monomer. The initial small depression in absorbance as compared to that of Teflon® AF is likely due to a difference in the amount of mol % PDD. Even at the highest EVE content measured, 18 mol %, the material is still very low absorbing and well below the 1 μm⁻¹ threshold required for photolithography.

TABLE 3

| | EVE | 157.6 nm | 193 nm |
|---|---|---|---|
| No. | (mol- %) | (μm⁻¹) | (μm⁻¹) |
| 5 | — | 0.13 | 0.01 |
| 9 | 12 | 0.25 | 0.01 |
| 2 | 18 | 0.57 | 0.02 |
| Teflon ® AF 1601 | — | 0.15 | 0.004 |
| poly(TFE-co-PDD)^{a} | — | 0.15 | 0.02 |

^{a}76/24 PDD/TFE (mol- %) synthesized in CO₂

Synthesis of other Teflon® AF-based materials. The above system has been extended, which provides another example of this invention, to include other ethylenically unsaturated functional compounds (e.g., tertiary butyl acrylate or methacrylate). The t-butyl group is cleaved upon exposure to acid (generated from a photoactive compound), which provides a solubility switch due to the resulting polymer being more or less soluble in the developing solution (i.e., positive or negative tone respectively). A series of TFE-containing polymers have been prepared, in addition, a series of non-TFE-based materials have also been synthesized (as shown below). These systems have been extended to include norbornene (NB) which serves to enhance the solubility of the resists in coventional solvents employed in the photolithographic process as well as improve etch resistance.

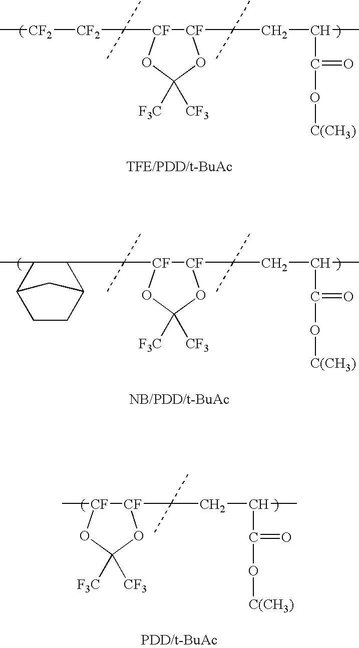

As mentioned, the ethylenically unsaturated functional compounds (e.g., t-BuAc) can be cleaved upon exposure to acid (generated from a photoactive compound) to provide a solubility switch for high resolution imaging (see below).

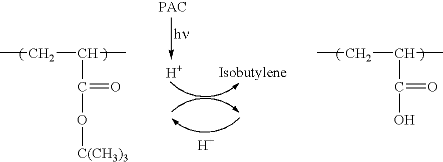

As can be seen (from left to right) the t-butyl group is cleaved, thus eliminating isobutylene and regenerating the acid. This process should provide the necessary contrast for high resolution imaging. The system is also chemically amplified so each molecule of photoactive compound (PAC) can cleave a number of groups.

A. Materials and Methods.

Reagents. TFE was obtained from DuPont as a 50 weight-% mixture in CO₂ and used as received. PDD (DuPont) was purified by filtration through silica gel (230-400 mesh, Sigma). t-butyl acrylate/methacrylate were obtained from Aldrich and purified by passage through neutral activated alumina. Norbornene (NB) was obtained from Aldrich and used as received. SFC purity CO₂ was obtained from Air Products. Di(4-tert-butylcyclohexyl) peroxydicarbonate (Perkadox® 16) was obtained from polymer chemicals and used as received.

Copolymerization. Polymerizations were conducted in a 25 mL high-pressure reaction view cell equipped with a stirring bar, thermocouple, rupture disc and a sapphire window permitting visual observation of the reaction mixture with an endoscope. The initiator was initially charged into the vessel (NB, when included, was also added). The vessel was then purged for 30 minutes with argon and subsequently cooled to 5° C. with an ice-bath before t-BuAc and PDD were charged via syringe while purging with argon. After sealing the cell the ice-bath was removed and the TFE/CO₂ mixture (50 wt.-%) was introduced (when employed) with a manual pump (HIP, Model 62-6-10) under stirring. To weigh in a determined amount of TFE the pump was pressurized to 103 bar (1500 psig). The volume of the TFE/CO₂ mixture was calculated from the density at 103 bar (1500 psig). By repeated opening of the valve between the pump and the reaction view cell and repressurizing to 103 bar (1500 psig) the calculated volume was introduced. During this procedure the temperature of the autoclave stayed below 10° C. The reaction view cell was then pressurized with CO₂ using an automatic syringe pump (ISCO, Model 260 D). Then the reaction view cell was heated to the desired reaction temperature (50° C.), the pressure at the reaction temperature was 3000 psig. After the reaction, the CO₂ was slowly released and the residual copolymer in the high-pressure cell was extracted three times to woth CO₂ (138 bar/2000 psig) to remove unreacted monomer.

Characterization. Glass transition temperatures were measured with a Seiko Instruments DSC 220 system under nitrogen. Heating rates for DSC measurements were 10 K/min. IR spectra were taken of polymer films on NaCl plates (Bruker IFS 66v/S). Thermogravimetric analysus (TGA) was taken on a Seiko RTG 220 to determine the temperature of decomposion and thermal cleavage of the unsaturated functional compound (tBuAc). Molecular weights were measured using a Waters 2690 GPC using THF as the solvent with retention times measured by a refractive index detector against polystyrene standards.

B. Results and Discussion

Influence of Reaction Conditions on Polymer Properties. A series of TFE-containing variants of Teflon®-AF were prepared in CO₂ as shown below. The polymers were isolated directly from the reactor in high yields. The resulting polymers had a range of different glass transition temperatures, and several possessed sufficiently high Tg's (>120° C.) for use as photoresists. The polymers exhibited solubilities comparable to Teflon®-AF (e.g., soluble in hexafluorobenzene).

| TFE | PDD | tBuAc | Yield | Initiator | |
|---|---|---|---|---|---|
| (mol %) | (mol %) | (mol %) | (%) | (mol %) | Tg |
| 20 | 73 | 7 | 54.7 | 1 | 86 |
| 20 | 62 | 18 | 42.7 | 1 | 96 |
| 20 | 55 | 25 | 20.8 | 1 | 120 |
| 20 | 55 | 25 | 53.5 | 0.5 | 132 |
| 20 | 55 | 25 | 15.3 | 0.26 | 139 |
| 10 | 65 | 25 | 42.8 | 0.5 | 141 |
| 30 | 45 | 25 | 35.7 | 0.5 | 48 |

Reaction Conditions: 50° C., 15 hrs, in CO₂ at 3000 psig using Perkadox ® 16 as the initiator.

These polymers are being evaluated as photoresists for use in 193 nm, 157 nm and immersion lithography as well as imageable low k dielectrics. Moreover, these materials have the added potential for CO₂-based deposition and development which would circumvent the use of copious amounts of deleterious solvents and prevent image collapse. The use of this commercially available, chemically amplified ethylenically unsaturated functional compound (e.g., t-BuAc) will extend the applicability of this Teflon®-AF based platform.

In addition, analogous polymers were prepared without the addition of TFE (see below). The first copolymer (NB/PDD/t-BuAc) was soluble in conventional solvents used in photolithography. This provides a handle in order to reinforce this approach by utilizing conventional solvents for deposition and development with the view to building on this with the TFE-based materials shown above. This should allow us to implement these novel materials in many of the new lithographic approaches, thus impacting several key next generation lithographic techniques.

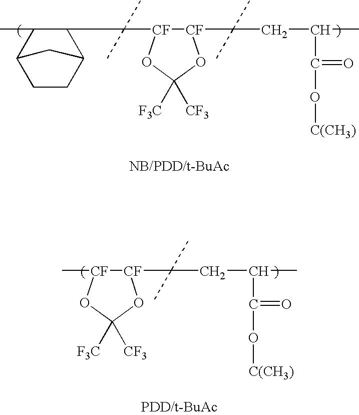

The PDD/t-BuAc copolymer was isolated in 64% yield with a Tg of 142° C. the NB-containing copolymer (yield of 22%) had a Tg of almost 150° C. Moreover this copolymer was soluble in propylene glycol monomethyl ether acetate (PGMEA) which is the industry standard for resist deposition by spin coating. The molecular weight of this polymer was also measured (Mw=2884 g/mol, Mn=2167 g/mol) which is sufficiently high to give a high Tg-material but is low enough to provide enhanced dissolution during development. This material has been spin coated onto a range of different size silicon wafers (2-6 inches). In addition, in the presence of a PAC (photoacid generator 336) the t-butyl group could be cleaved with UV light and was confirmed by IR spectroscopy. The resulting carboxylic acid functionalized polymer was soluble in the standard base developing solution, tetramethyl ammonium hydroxide (TMAH), whereas the protected polymer was insoluble. This should provide the necessary contrast for high resolution images. The absorbance of these materials are being measured by Will Conley at International SEMATECH using a VUV-VASE. These materials will be imaged in the near future.

In conclusion, TFE/PDD/EFE terpolymers were synthesized in CO₂ at low temperatures for the first time. Terpolymers with different compositions were prepared having a broad range of glass transition temperatures from 109° C. to 160° C. A Plackett-Burman model was used to study the effects of monomer feed, initiator concentration, temperature, pressure and reaction time. NMR and IR spectroscopy confirmed incorporation of EVE into the polymer chain. These materials exhibit very low absorbance at 157.6 nm and 193 nm. Cleavage of the EVE ester group with acid was demonstrated suggesting that EVE and EVE analogues may be used as a functional group providing a solubility contrast. In addition, a series of polymers utilizing other ethylenically unsaturated functional compound (e.g., t-BuAc) were synthesized. These materials extend this approach by providing a wider range of materials with prerequisite properties to impact several key next generation lithographic techniques (193 nm, 157 nm and immersion lithography) as well as imageable dielectrics.

The foregoing is illustrative of the present invention, and is not to be construed as limiting thereof. The invention is defined by the following claims, with equivalents of the claims to be included therein.

1. A photoresist comprising:
(a) a compound that is a terpolymer of:
(i) at least one ethylenically unsaturated linear or branched compound that has at least one fluorine atom covalently coupled thereto;
(ii) at least one ethylenically unsaturated precursor of a cyclic or polycyclic compound that has at least one fluorine atom covalently coupled thereto forming a cyclic or polycyclic decrystallizing monomer in said terpolymer; and
(iii) at least one ethylenically unsaturated functional compound which as a monomer in said terpolymer changes solubility upon exposure to an acid or base; and
(b) a photoactive component.

2. The photoresist of claim 1, wherein said at least one ethylenically unsaturated linear or branched compound is selected from the group consisting of tetrafluoroethylene, chlorotrifluoroethylene, trifluoroethylene, vinylidene fluoride, and vinyl fluoride.

3. The photoresist of claim 1, wherein said at least one ethylenically unsaturated precursor of a cyclic or polycyclic compound is a cyclic compound having the formula:

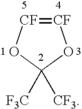

4. The photoresist of claim 1, wherein said at least one ethylenically unsaturated precursor of a cyclic or polycyclic compound has the formula CF₂═CFCF₂CF₂OCF═CF₂.

5. The photoresist of claim 1, wherein said at least one ethylenically unsaturated precursor of a cyclic or polycyclic compound is selected from the group consisting of: 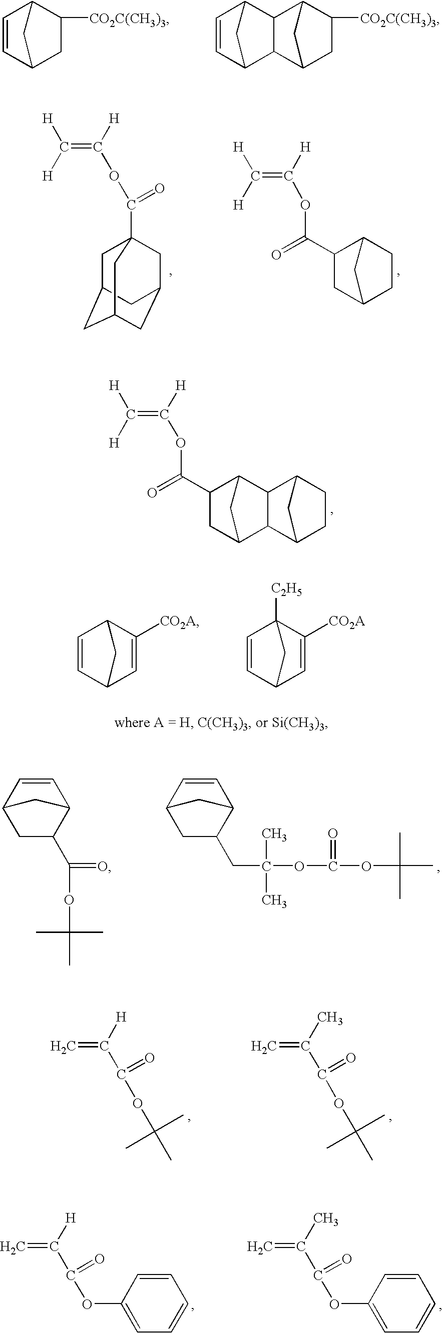 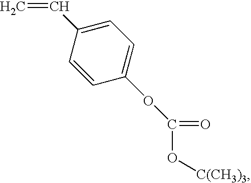
vinyl acetate, tert-butyl acrylate, and 5-norbornene-2-carboxylic acid tert-butyl ester.

6. The photoresist of claim 1, wherein said at least one ethylenically unsaturated functional compound has at least one fluorine atom covalently coupled thereto.

7. The photoresist of claim 1, wherein said at least one ethylenically unsaturated functional compound is an ester vinyl ether.

8. The photoresist of claim 1, wherein said at least one ethylenically unsaturated functional compounds is a fluorinated ester vinyl ether.

9. The photoresist of claim 1, wherein said at least one ethylenically unsaturated functional compounds is a fluorinated ester vinyl ether selected from the group consisting of:

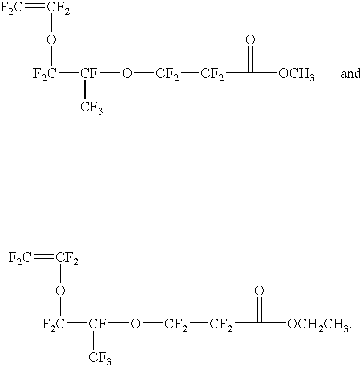

10. The photoresist of claim 1, wherein said at least one photoactive component is a photoacid generator.

11. The photoresist of claim 1, wherein said at least one photoactive component is a photobase generator.

12. A process for preparing a photoresist image on a substrate, comprising:
(a) applying a photoresist composition on a substrate, wherein said photoresist composition comprises (i) a terpolymer of claim 1, (ii) a photoactive component, and (iii) a solvent;
(b) drying the photoresist composition to substantially remove the solvent and thereby form a photoresist layer on the substrate;
(c) imagewise exposing the photoresist layer to form imaged and non-imaged areas; and
(d) developing the exposed photoresist layer having imaged and non-imaged areas to form the relief image on the substrate.

13. The process of claim 12, wherein said solvent comprises carbon dioxide.

14. The process of claim 12, wherein said imagewise exposing is performed using ultraviolet radiation.

15. The process of claim 12, wherein said imagewise exposing is performed using ultraviolet radiation having a wavelength of 157 nm or 193 nm.

16. The process of claim 12, wherein said developing step is carried out with a supercritical solution comprising carbon dioxide.

17. A method of making a terpolymer of claim 1, comprising the steps of:
(a) providing a bipolymer of (i) at least one ethylenically unsaturated linear or branched compound that has at least one fluorine atom covalently coupled thereto and (ii) at least one ethylenically unsaturated cyclic or polycyclic compound that has at least one fluorine atom covalently coupled thereto forming a decrystallizing monomer in said terpolymer; and
(b) reacting said bipolymer with at least one ethylenically unsaturated functional compound which as a monomer in said terpolymer changes solubility upon exposure to an acid or base in a carbon dioxide solvent produce the terpolymer of claim 1.

18. The method of claim 17, wherein said carbon dioxide is liquid carbon dioxide.

19. The method of claim 17, wherein said carbon dioxide is supercritical carbon dioxide.

20. The method of claim 17, wherein said bipolymer is produced in a carbon dioxide solvent.
